(19) United States
(12) Patent Application Publication
(10) Pub. No.: US 2002/0145755 A1
(43) Pub. Date: Oct. 10, 2002

(54) Printing system, printing method and order-receiving server

(76) Inventors: Yasuhiro Yamazaki, Ibaraki-ken (JP); Junichi Hakamada, Ibaraki-ken (JP); Yuichi Takahashi, Ibaraki-ken (JP)

Correspondence Address: NATH & ASSOCIATES, 1030 15th STREET, 6TH FLOOR, WASHINGTON, DC, 20005, US

(21) Appl. No.: 10/117,056

(22) Filed: Apr. 8, 2002

(30) Foreign Application Priority Data
Apr. 10, 2001 (JP) P2001-111477

(51) Int. Cl. B41J 1/00; G06F 15/00; H04N 1/00

(52) U.S. Cl. 358/1.15; 358/402

(57) ABSTRACT

A printing system for accepting an order for a print processing from a user as an orderer, through a communication network, for executing the ordered print processing, and for delivering completed prints to the user as the orderer of the print processing, includes (a) an order-receiving server configured to show image data for samples to the user, to receive the order for the print processing for the image data desired by the user as the orderer, to select the nearest printing works to the user as the orderer from a plurality of printing works, and transmit print Instruction information including identification code of the image data related to the ordered print processing, the number of prints and information about the user as the orderer, to the selected printing works through the communication network, and (b) a printing works system provided in each of the printing works, including a memory section storing the image data for printing corresponding to the sample image data in advance, and configured to read the image data corresponding to the identification code from among the image data for printing stored in the memory section according to the print instruction information received from the order-receiving server, and configured to execute the print processing to the read image data.

### BACKGROUND OF THE INVENTION

1. Field of the Invention

The present invention relates to a technique adaptable to ordered-printing, which utilizes a communication network such as the Internet.

2. Description of Related Art

As a communication network technology has advanced swiftly in recent years, for example, various services utilizing the Internet as a communication means have been provided. Among these services, there is a known service, which downloads image data for illustrations In postcards or the like using the Internet. According to this service, a web server, which is equipped with a memory section storing image data for download is connected to the Internet. A user accesses the web server through the Internet, whereby the user can view the Image data for download from the memory section through the Internet. In addition, in response to user's download order, the image data for download is downloaded to the user.

In addition to the service stated above, there has been recently provided a so-called ordered-printing service for printing image data ordered from a user on postcards and delivering the image-printed postcards to the user. According to this ordered-printing service, ordered image data is transmitted from a web server to a printing works through the Internet, the image data thus transmitted is printed at the printing works and the image-printed postcards or the like are delivered to the user.

In the case of the bandwidth of a communication network is not sufficiently narrow, it takes a long transmission time to transmit image data from the web server to the printing works. It is assumed that the web server accepts 500 orders from users at a data quantity of 1 Mbytes per image data. In this case, 500 items of image data each of 1 Mbytes are daily transmitted from the web server to the printing works, whereby the data length amounts to 500 Mbytes. It is also assumed that the data of such a quantity is to be transmitted through, for example, a communication network at a bandwidth of 64 kbps. At least, it would take a transmission time of 17 hours and 21 minutes. This situation leads to the long time from an order received of prints to delivery, and it heats it, and the efficiency of ordered-printing service not only falls, but it causes social obstacles, such as low late of the access speed by the high traffic of the communication network.

### SUMMARY OF THE INVENTION

A printing system in one embodiment of the present invention for accepting an order for a print processing from a user as an orderer, through a communication network, for executing the ordered print processing, and for delivering printed matters to the user as the orderer of the print processing, includes (a) an order-receiving server configured to show image data for samples to the user, to receive the order for the print processing for the image data desired by the user, to select the nearest printing works to the user as the orderer from a plurality of printing works, and to transmit print instruction information including identification code of the image data related to the ordered print processing, the number of prints and information about the user as the orderer to the selected printing works through the communication network, and (b) a printing works system provided in each of the printing works, including a memory section storing the image-data for printing corresponding to the sample image data in advance, and configured to read the image data corresponding to the identification code from among the image data for printing stored in the memory section according to the print instruction information received from the order-receiving server, and configured to execute the print processing to the read image data.

In addition, a printing method in one embodiment of the present invention using a printing system including an order-receiving server receiving an order for a print processing from a user as an orderer through a communication network, and a plurality of printing works systems each executing the ordered print processing, and delivering completed prints to the user as the orderer of the print processing, includes (a) showing image data for samples to the user at the order-receiving server, (b) receiving the order for the print processing for the image data desired by the user as the orderer from the showed sample image data, and selecting the nearest printing works system to the user as the orderer from the plurality of printing works systems, at the order-receiving server, (c) transmitting print instruction information including identification code of the image data related to the ordered print processing, the number of prints and information about the user as the orderer, to the selected printing works system through the communication network, at the order-receiving server, (d) reading the image data to-be-printed corresponding to the identification code from among the image data for printing stored in a memory section in advance according to the print instruction information received from the order-receiving server at the selected printing works system, and (e) executing the print processing to the read image data to-be-printed at the selected printing works system.

Furthermore, an order-receiving server in one embodiment of the present invention employed in a printing system, receiving an order for a print processing from a user as an orderer through a communication network, executing the ordered print processing, and delivering completed prints to the user as the orderer of the print processing, includes (a) means for showing image-data for samples to the user as the orderer, (b) means for receiving the order for the print processing for image data desired by the user from among the showed sample image data, (c) means for selecting the nearest printing works system to the user as the orderer from a plurality of printing works systems each storing the image data for printing corresponding to the sample image data, and (d) means for transmitting print instruction information including identification code of the image data to-be-printed related to the ordered print processing, the number of prints and information about the user as the orderer, to the selected printing works system through the communication network.

### BRIEF DESCRIPTION OF THE DRAWINGS

FIG. 1 is a schematic view showing the configuration of an ordered-printing system in the first embodiment of the present invention;

FIG. 2 is a schematic view showing one example of the configuration of an order-receiving server shown in FIG. 1;

FIG. 3A is a schematic view showing one example of the configuration of a satellite printing works system shown in FIG. 1, and FIG. 3B is a schematic view showing one example of the configuration of a management server shown in FIG. 3A;

FIG. 4 is a flow chart showing an ordered-printing method employing the printing system in the first embodiment;

FIG. 5 is a schematic view showing the display image of an order screen, which the order-receiving server shown in FIG. 1 displays on the display of a user PC;

FIG. 6 shows the data format of print instruction information transmitted from the order-receiving server to the satellite printing works system in the first embodiment; and

FIG. 7 shows the data format of print instruction information transmitted from the order-receiving server to the satellite printing works system in the other embodiment.

### DETAILED DESCRIPTION

The embodiments of the present invention will be described hereinafter with reference to the drawings. It is to be noted that the same or similar reference numerals are applied to the same or similar parts and elements throughout the drawings, and the description of the same or similar parts and elements will be omitted or simplified.

A printing system in one embodiment of the present invention can be applied to a printing system allowing a printing works to print ordered image data, for example, according to a print order received through a communication network, for example the Internet and which delivers completed prints to a user as an orderer. This printing system can efficiently manage the ordered-printing service employing a communication network having the maximum data transmission rate.

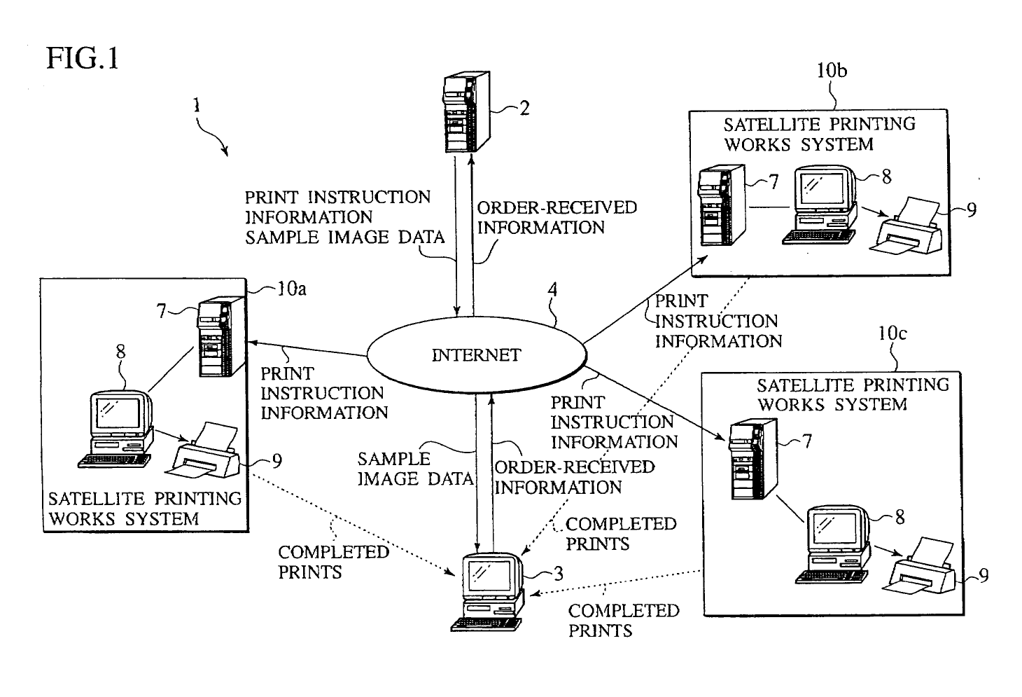

Referring to FIGS. 1 to 6, the configuration and the operation of the printing system in this embodiment applied to and worked for an ordered-printing system 1 will be described in detail.

<<Configuration of Print System>>

The configuration of the printing system in the first embodiment of the present invention will first be described with reference to FIGS. 1 to 3.

As shown in FIG. 1. the ordered-printing system 1 in this embodiment is configured so that a user PC (Personal Computer) 3, an order-receiving server 2 and a plurality of satellite printing works systems 10a, 10b and 10c are connected to one another through the Internet 4.

The user PC 3 is configured to be capable of transmitting and receiving various information to and from the order-receiving server through the Internet 4.

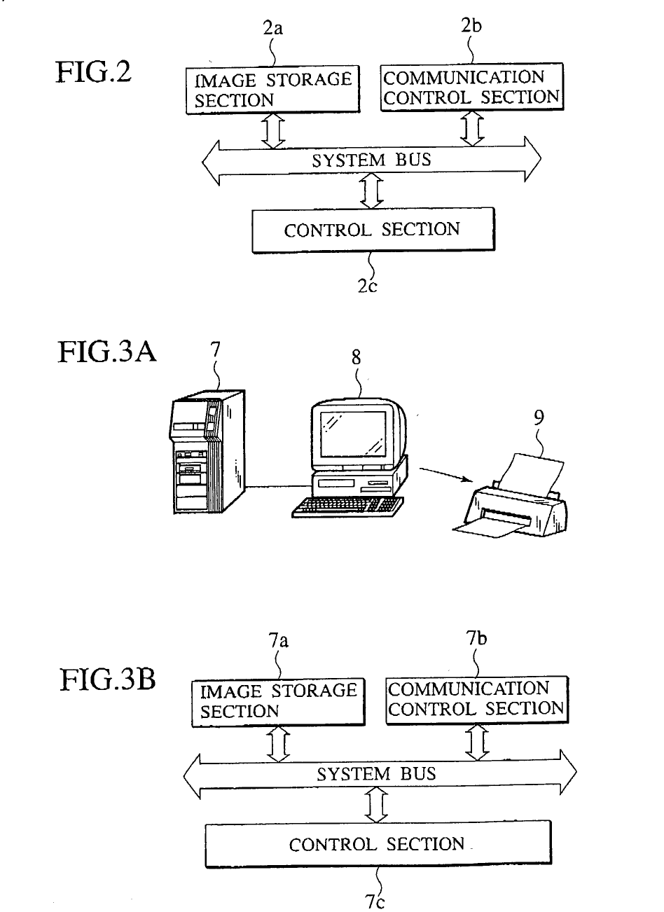

As shown in FIG. 2, the order-receiving server 2 is configured so that an image storage section 2a storing image data for samples and to be displayed for a user connected to the order-receiving server 2 through the Internet 4, a communication control section 2b controlling data communication processing between the user PC 3 and the satellite printing works systems 10a, 10b, and 10c, and a control section 2c controlling various processing (to be described later) related to ordered-printing processing, including an authentication processing and an accounting processing, are connected to one another through a system bus.

As shown in FIG. 3A, each of the satellite printing works systems 10a, 10b and 10c provided in printing works comprises a management server 7, a printer server 8 and a printer 9.

As shown in FIG. 3B, the management server 7 is configured so that an image storage section 7a storing original image data for printing which is original corresponding to the sample image data stored in the image storage section 2a of the order-receiving server 2, in advance, a communication control section 7b controlling data communication processing with the order-receiving server 2, and a control section 7c controlling various processing (to be described later) related to print processing are connected to one another through a system bus.

The management server 7 controls print processing based on print instruction information transmitted from the order-receiving server 2.

The printer server 8 executes print processing using the printer 9 connected to the printer server 8 according to the instructions from the management server 7.

<<Operation of Printing System>>

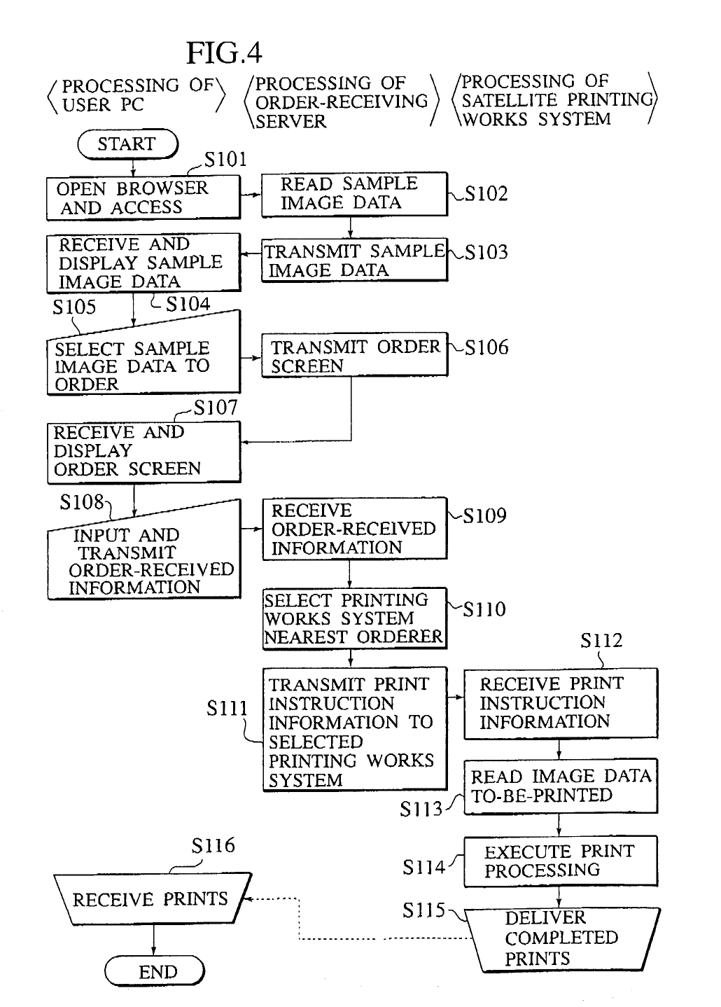

The operation of the ordered-printing system 1 in the first embodiment will next be described in detail with reference to FIG. 4.

In the ordered-printing system 1, when a user, an orderer, opens a web browser and accesses the order-receiving server 2 by the user PC 3 through the Internet 4 (Step S101), the control section 2c of the order-receiving server 2 reads image data for samples from the image storage section 2a (Step S102) and transmits the sample image data to the user PC 3 through the Internet (Step S103).

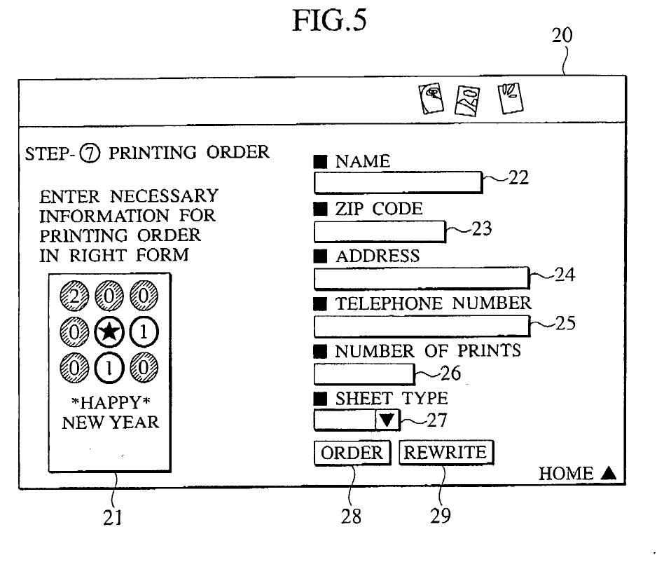

The user pc 3 receives and displays the sample image data (Step S104). When the user finds an image data for which a print processing is to be carried out while referring to the displayed sample image data, the user clicks on the image data by, for example, a mouse pointer and selects the image data for which the user places a print processing order (Step S105). When the user orders the print processing, the control section 2c transmits an order screen 20 shown in, for example, FIG. 5 to the user PC 3 (Step S106). On the order screen 20, the sample image data 21 selected by the user appears. In addition, on the order screen 20, required items input areas for a name 22, a zip code 23, an address 24, a telephone number 25, number of prints 26, a sheet type 27 and the like as well as an order button 28 and a rewrite button 29 are provided. The input area of the name 22, the zip code 23, the address 24 and the telephone number 25 are the input areas into which information of the user as the orderer is input. The input data becomes destination data on completed prints. The number of prints 26 indicates the number of prints to be ordered. The sheet type 27, such as postcards or letters, are designed by the pull down menu system.

When the order screen 20 is output to the user PC 3 (Step S107), the user as the orderer inputs required items in the input areas on the order screen 20, clicks the order button 28 and orders a print processing for the selected image data. The required items inputted on the order screen 20 are transmitted, as order-received information, from the user PC 3 to the order-receiving server 2 (Step S108).

Through a series of processing stated above, the print processing is ordered from the user PC 3 to the order-receiving server 2. When the order-received information is transmitted to the order-receiving server 2, the control section 2c of the order-receiving server 2 receives the contents of an order (order-received information) (Step S109), executes an authentication processing and an accounting processing according to the contents of the order-received information and then executes the following processing.

First, the control section 2c selects a satellite printing works system nearest to the destination of prints from among the satellite printing works systems 10a, 10b, and 10c which are sporadically located while referring to the zip code and/or the address of the destination data described in the received order-received information (Step S110). The processing of the step S110 is executed, for example, as follows. The area of the respective satellite printing works systems 10a, 10b, and 10c in its duty are determined in advance, and it memorizes as data. If the satellite printing works system nearest to the destination of the printed matters is selected, this data is referred to for a search as to which satellite printing works system is responsible for, the area in its duty that the zip code and/or the address of the destination correspond to. In the case of an ordered-printing service, delivery of prints to the user as the orderer requires transportation means, Therefore, the shorter the transportation distance between the printing works and the user as the orderer, the shorter the delivery time. Accordingly, the ordered-printing service is designed to locate printing works in a wide area and to transmit image data for printing from the web server, which receives an order, to the printing works system nearest to the destination.

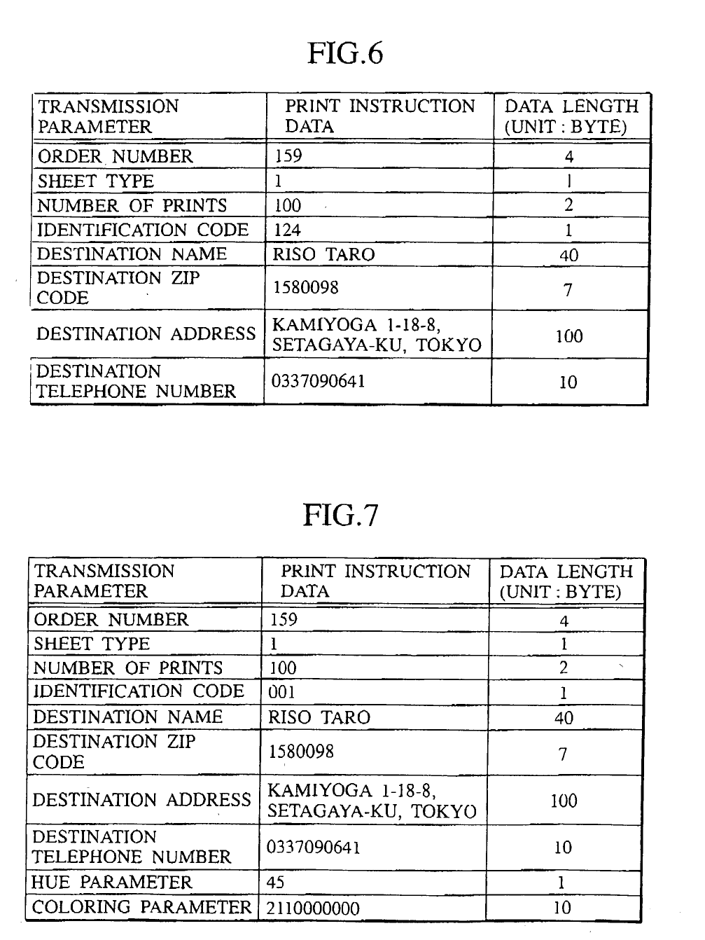

When a satellite printing works system is selected as a result of the processing in the step S110, the control section 2c then transmits the identification code of the image data to-be-printed and destination information (print instruction information) thereon to the management server 7 of the selected satellite printing works system while referring to the order-received information (Step S111). In the first embodiment, the print instruction information has a data format shown in FIG. 6. Namely, the print instruction information stores an order number (4 bytes) for a bill processing, a sheet type for printing (1 byte), the number of prints (2 bytes), the identification code of the image data selected by the user (1 byte), the name of a destination (40 bytes), the zip code of the destination (7 bytes). the address of the destination (100 bytes), and the telephone number of the destination (10 bytes) by respective data lengths in parentheses. In addition, the control section 2c generates the order number and the identification code automatically according a control program. According to this data format, the data length of the print instruction information is 1,320 bits. Therefore, if there are 500 pieces of print instruction information, the data length thereof amounts to 660,000 bits. If the print instruction information is transmitted through the communication network of a bandwidth of 64 kbps, the print instruction information can be transmitted in time of about 10 sec.

When the management server 7 of the selected satellite printing works system receives the print instruction information from the order-receiving server 2 (Step S112), the management server 7 reads the image data to-be-printed from the image storage section 7a while referring to the identification code in the print instruction information (Step S113). The management server 7 then transmits Information about the sheet type and the number of prints as well as the read image data to-be-printed to the printer server 8 which is connected to the management server 7. When receiving the sheet type and the number of prints, the printer server 8 controls the printer 9 to execute a print processing according to the received contents (Step S114).

As a result of the above-stated processing, the prints which printed the image data for which the user placed the order are completed. Following this, operations are executed so that the completed prints are packed and delivered to the destination designated in the print instruction information (Step S115), and that the user receives the prints (Step S116), whereby an ordered-printing processing is completed.

As stated above, according to the ordered-printing system 1 in the first embodiment, the image data for printing is stored in advance in the management server 7 of the satellite printing works system 10a, 10b and 10c.

When the user places an order for an ordered-printing processing, the order-receiving server 2 selects for the nearest satellite printing works system to the destination and transmits order-received information including information as to the identification code and printing number of sheets which image data are to be printed and destination data including the address and the name of the destination, to the nearest satellite printing works system to the destination. The satellite printing works system which receives the order-received information and the destination data, reads the image data to-be-printed from the image storage section 7a stored in advance while referring to the order-received information, and executes print processing for the image data read based on the order-received information. Thereafter, the satellite printing works delivers prints to the destination while referring to the destination data.

According to the ordered-printing system 1 constituted as stated above, it is unnecessary to transmit large amount of Image data from the order-receiving server 2 to the respective satellite printing works systems 10a, 10b, and 10c and it is possible for each of the satellite printing works system to receiving the print instruction information In a short time. It is, therefore, possible to considerable reduce the time required for overall ordered print processing. It is possible to efficiently manage the ordered-printing service, which uses communication network having maximum data transmission rate accordingly.

<<Other Embodiments>>

The invention attained by the inventors of the present invention has been described as the first embodiment. It should not be interpreted that the description and the drawings, which form a part of this disclosure, limit the present invention. Those skilled in the art could obviously contrive various alternatives, embodiments and applied techniques based on this disclosure.

Other systems, in addition to order-received information, such as identification code of image data to-be-printed and printing number of sheets, may be the system configurations which can be ordered from the user PC 3 to the order-received server 2 about printing of the data which processing of image data was possible and was processed from the user PC 3.

In this case, the order-receiving server 2 and the satellite printing works systems 10a, 10b, and 10c have the same image processing program. The user as an orderer executes a desired image data processing using the image processing program on the order-receiving server 2 from the user PC 3. When receiving an order for the ordered print processing from the user as the orderer. the order-receiving server 2 transmits parameters related to the executed image data processing as well as the print instruction information to the satellite printing works systems.

Here, concrete image processing has hue rotation processing and color processing. It says that the hue rotation processing changes hue of each pixel of image data. With for example, Hue Saturation Value (HSV) Color Space, red is expressed by zero degree, yellow is made into 60 degrees, green is made into 120 degrees, cyan is made into 180 degrees, blue is made into 240 degrees, and magenta is made into 300 degrees. Hue changes continuously in correspondence with an angle. Namely, hue of each pixel for example, simultaneous 60 degrees increasing (it rotating), red is changed to yellow, and yellow is changed to green. Hue rotation processing can change hue of image data. Therefore, the increase angle (rotation angle) of hue is defined as a hue parameter. The rotation angle of about 20 degrees is enough practical.

Coloring processing divides image data into the domain beforehand made into the same color, and means the processing which specifies coloring for every division domain. Therefore, hue for every division domain and the combination of a pattern which were specified are defined as a coloring parameter. The combination of a grade is enough 2,560 passages practical.

In this case, the order-receiving server 2 transmits, for example, a hue parameter (1 byte) and a coloring parameter (10 bytes) shown in FIG. 7 as well as the print instruction information to the satellite printing works systems. Even if the hue parameter and the coloring parameter are added to the information to be transmitted to the satellite printing works system, the total data length of the data transmitted is 1,408 bits. Therefore, transmission time can be as short as about 11 sec, without any problem in the transmission time.

If the order-receiving server 2 transmits only the image data for printing to the satellite printing works systems, it is possible to reduce the length of the data transmitted to some extent by not transmitting overlapped image data. However, the print processing of image data which carried out image processing is received, the contents of the image processing of the image data for printing which carried out image data processing differ in many cases. In this case, therefore, by transmitting the image processing parameters from the order-receiving server 2 to each satellite printing works system and allowing each satellite printing works system to execute image processing. The transmitting time of print instruction information and an image processing parameters are shortened. Image processing was added, and hears, and short-time correspondence of print processing is enabled.

Although the embodiments of the present invention have been described in detail, the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

As stated above, it is unnecessary to transmit image data having a huge data length from the order-receiving server to each satellite printing works system and each satellite printing works system can shorten the receiving time of print instruction information, thereby greatly reducing time required to carry out the entire ordered print processing. It is, therefore, possible to efficiently manage the ordered-printing service using the communication network having a maximum data transmission rate.

### CROSS REFERENCE TO RELATED APPLICATIONS

This application claims benefit of priority under 35 USC §119 to Japanese Patent Application No. 2001-111477 filed on Apr. 10, 2001, the entire contents of which are incorporated by reference herein.

What is claimed is:

1. A printing system for accepting an order for a print processing from a user as an orderer, through a communication network, for executing the ordered print processing, and for delivering completed prints to the user as the orderer of the print processing, the system comprising:
an order-receiving server configured to show image data for samples to the user, to receive the order for the print processing for the image data desired by the user as the orderer, to select the nearest printing works to the user as the orderer from a plurality of printing works, and to transmit print instruction information including identification code of the image data related to the ordered print processing, the number of prints and information about the user as the orderer to the selected printing works through the communication network; and
a printing works system provided in each of the printing works, including a memory section storing the data for printing corresponding to the sample image data in advance, configured to read the image data corresponding to the identification code from among the image data for printing stored in the memory section according to the print instruction information received from the order-receiving server, and configured to execute the print processing to the read image data.

2. The printing system according to claim 1, wherein
the order-receiving server receives processing instruction information for processing the image data to be printed from the user as the orderer, and transmits the received processing instruction information as well as the print instruction information to the printing works system; and
the printing works system processes the image data read from the memory section and executes the print processing using the processed image data according to the processing instruction information received from the order-receiving server.

3. The printing system according to claim 2, wherein
the processing instruction information includes information for instructing hue rotation processing and color processing to be executed to the image data to-be-printed.

4. The printing system according to claim 1, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the information on the type of sheets received from the order-receiving server.

5. The printing system according to claim 2, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the information on the type of sheets received from the order-receiving server.

6. The printing system according to claim 3, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the information on the type of sheets received from the order-receiving server.

7. The printing system according to claim 1, wherein
the order-receiving server selects the nearest printing works to the user as the orderer based on one of or both of zip code data and address data included in information about the user as the orderer.

8. A printing method using a printing system comprising an order-receiving server receiving an order for a print processing from a user as an orderer through a communication network, and a plurality of printing works systems each executing the ordered print processing, and delivering completed prints to the user as the orderer of the print processing, the method comprising:
showing image data for samples to the user at the order-receiving server;
receiving the order for the print processing for the image data desired by the user as the orderer from the showed sample Image data, and selecting the nearest printing works system to the user as the orderer from the plurality of printing works systems, at the order-receiving server;
transmitting print instruction information including identification code of the image data related to the ordered print processing, the number of prints and information about the user as the orderer, to the selected printing works system through the communication network, at the order-receiving server;
reading image data to-be-printed corresponding to the identification code from among the image data for printing stored in a memory section in advance according to the print instruction information received from the order-receiving server at the selected printing works system; and
executing the print processing to the read image data to-be-printed at the selected printing works system.

9. The printing method according to claim 8, wherein
the order-receiving server receives processing instruction information for processing the image data to be printed from the user as the orderer, and transmits the received processing instruction information as well as the print instruction information to the printing works system; and
the printing works system processes the image data read from the memory section and executes the print processing using the processed image data according to the processing instruction information received from the order-receiving server.

10. The printing method according to claim 9, wherein
the processing instruction information includes information for instructing hue rotation processing and color processing to be executed to the image data to-be-printed.

11. A printing method according to claim 8, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the Information on the type of sheets received from the order-receiving server.

12. The printing method according to claim 9, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the information on the type of sheets received from the order-receiving server.

13. The printing method according to claim 10, wherein
the order-receiving server receives information on a type of sheets on which the image data is printed from the user as the orderer, and transmits the received information on the type of sheets as well as the print instruction information to the printing works system; and
the printing works system selects sheets to which the print processing is to be executed according to the information on the type of sheets received from the order-receiving server.

14. The printing method according to claim 8, wherein
the order-receiving server selects the nearest printing works based on one of or both of zip code data and address data included in information about the user as the orderer.

15. An order-receiving server employed in a printing system, receiving an order for a print processing from a user as an orderer through a communication network, executing the ordered print processing, and delivering completed prints to the user as the orderer of the print processing, the server comprising:
means for showing image data for samples to the user as the orderer;
means for receiving the order for the print processing for image data desired by the user from among the showed sample image data;
means for selecting the nearest printing works system to the user as the orderer from a plurality of printing works systems each storing the image data for printing corresponding to the sample image data; and
means for transmitting print instruction information including identification code of the image data to-be-printed related-to the ordered print processing, the number of prints and information about the user as the orderer, to the selected printing works system through the communication network.

16. The order-receiving server according to claim 15, wherein
the order-receiving server receives processing instruction information for processing the image data to be printed from the user as the orderer, and transmits the received processing instruction information as well as the print instruction information to the printing works system.

17. The order-receiving server according to claim 16, wherein
the processing instruction information includes information for instructing hue rotation processing and color processing to be executed to the image data to-be-printed.

18. The order-receiving server according to claim 15, wherein
the order-receiving server receives information on a type of sheets on which the image data is printed from the user as the orderer, and transmits the received information on the type of sheets as well as the print instruction information to the printing works system.

19. The order-receiving server according to claim 15, wherein
the order-receiving server selects the nearest printing works to the user as the orderer based on one of or both of zip code data and address data included in information about the user as the orderer.
